(19) United States
(12) Patent Application Publication
(10) Pub. No.: US 2024/0426387 A1
(43) Pub. Date: Dec. 26, 2024

(54) EXCESS FLOW VALVE FOR CRYOGENIC FLUID TANK

(71) Applicant: Engineered Controls International, LLC, Elon, NC (US)

(72) Inventors: Zhao Zhang, Shanghai (CN); Guangbin Cao, Shanghai (CN)

(21) Appl. No.: 18/682,562

(22) PCT Filed: Aug. 30, 2021
(86) PCT No.: PCT/CN2021/115338

§ 371 Date: Feb. 9, 2024

(51) Int. Cl. F16K 17/30; F17C 13/04

(52) U.S. Cl. CPC F16K 17/30; F17C 13/04; F16K 2200/401; F17C 2205/0332; F17C 2223/0161

(57) ABSTRACT

An excess flow valve for cryogenic fluid is disclosed. An example excess flow valve includes a body, a piston plug, and a spring. The body includes a valve seat and an inner body surface that defines an inlet, an outlet, and a chamber. The piston plug is disposed within the chamber. The piston plug includes a plug that is configured to engage the valve seat in a closed position and be disengaged from the valve seat in an open position. The piston plug includes an inner piston surface, an outer piston surface, and an flange that extends from the outer piston surface and defines a flange surface. The flange, the outer piston surface, and the inner body surface at least partially define a spring slot outside of the fluid flow path. The spring is disposed in the spring slot to bias the piston plug toward the open position.

### TECHNICAL FIELD

This disclosure generally relates to cryogenic fluids and, more particularly, to excess flow valves for cryogenic fluid tanks.

### BACKGROUND

Cryogenic fluids, such as liquid hydrogen, has been used as fuel for machines, such as vehicles. Oftentimes, the cryogenic fluid is initially stored in a storage tank of a filling station. The cryogenic fluid is then transferred from the storage tank of the filling station to a fill tank of a vehicle for subsequent use as fuel for the machine. For instance, the filling station may include a nozzle that is connected to a hose extending from and fluidly connected to the storage tank of the filling station. A corresponding receptacle may be connected to the fill tank of the vehicle. To complete a filling sequence, an operator connects the nozzle to the receptacle. The cryogenic fluid subsequently flows from the storage tank of the filling station and into the fill tank of the vehicle.

In some instances, cryogenic fluid may flow too quickly through the filling station, thereby potentially resulting in spillage of cryogenic fluid from the filling station and/or damage to the filling station. To deter such an event from occurring, filling stations may implement an excess flow valve designed to limit the flow rate of cryogenic fluid to a predefined threshold. Further, an excess flow valve may be implemented on an engine fuel supply line of an engine that uses the cryogenic fluid as fuel to deter a spillage event during the operation of the engine. However, some excess flow valves may become less effective over time with repeated use.

### SUMMARY

An example excess flow valve disclosed herein for cryogenic fluid includes a valve body. The valve body includes an inner body surface that defines an inlet, an outlet, and a chamber extending between the inlet and the outlet. The valve body also includes a valve seat adjacent the outlet. The example excess flow valve also includes a piston plug disposed within the chamber and configured to slide axially between an open position and a closed position. The piston plug includes an inlet end positioned toward the inlet of the valve body, an outlet end positioned toward the outlet of the valve body, a plug at the outlet end configured to engage the valve seat in the closed position and be disengaged from the valve seat in the open position, an inner piston surface defining at least a portion of a fluid flow path for the cryogenic fluid between the inlet and the outlet, an outer piston surface, and an outer flange extending radially outward from the outer piston surface at the inlet end. The outer flange defines a flange surface. The outer flange, the outer piston surface, and the inner body surface at least partially define a spring slot that is outside of the fluid flow path. The example excess flow valve also includes a spring disposed in the spring slot. The spring includes a first end that engages the flange surface to bias the piston plug toward the open position.

In some examples, the valve body includes an inner ledge extending into the chamber between the inlet and the outlet. In some such examples, the inner ledge partially defines the spring slot and defines a fixed surface that engages a second end of the spring. Some such examples further comprise a guide adjacent the inner ledge. The guide includes a side surface that engages the inner ledge and a fixed surface that partially defines the spring slot and engages a second end of the spring. Further, in some such examples, the guide further includes an outer guide surface that engages the inner body surface of the valve body and an inner guide surface that engages the outer piston surface of the piston plug.

In some examples, the piston plug defines one or more holes that define a portion of the fluid flow path between the inlet and the outlet. The one or more holes are located adjacent the plug such that the one or more holes are axially positioned between the spring slot and the valve seat in both the open position and the closed position to direct the cryogenic fluid around the spring in both the open position and the closed position.

In some examples, the plug is configured to be disengaged from the valve seat in the open position when the spring is in an extended state, and the plug is configured to engage the valve seat in the closed position when the spring is in a compressed state.

In some examples, the piston plug is configured to slide axially toward the valve seat when a flow rate of the cryogenic fluid exceeds a predefined threshold flow rate that corresponds with a biasing force of the spring. In some such examples, the outer flange is configured to compress the spring as the piston plug slides axially toward the valve seat.

In some examples, the plug of the piston plug defines a bleed hole that fluidly connects the inlet to the outlet when the piston plug is in the closed position to subsequently facilitate the piston plug in returning to the open position by equalizing pressure between the chamber to the outlet.

In some examples, the inlet is configured to receive and fluidly connect to a first pipe, and the outlet is configured to receive and fluidly connect to a second pipe.

In some examples, the inlet has a diameter greater than that of the piston plug and the spring to enable the piston plug and the spring to be inserted into the chamber through the inlet. The valve seat has a diameter less than that of the piston plug and the spring to prevent the piston plug and the spring from being removed from the chamber through the outlet.

Some examples further comprise a retainer ring securely positioned within the chamber adjacent the inlet to retain the piston plug and the spring in place within the chamber. In some such examples, the inner body surface of the valve body defines a circumferential groove configured to receive the retainer ring. In some such examples, the outer flange of the piston plug is configured to rest against the retainer ring in the open position.

### BRIEF DESCRIPTION OF THE DRAWINGS

FIG. 1 is an example excess flow valve in accordance with the teachings herein.

FIG. 2 is an exploded perspective view of the excess flow valve of FIG. 1.

FIG. 3 is a cross-sectional view of a valve body of the excess flow valve of FIG. 1.

FIG. 4 is a cross-sectional view of a piston plug of the excess flow valve of FIG. 1.

FIG. 5 is a front view of a retainer ring of the excess flow valve of FIG. 1.

FIG. 6 is a cross-sectional view of a guide of the excess flow valve of FIG. 1.

FIG. 7 is a cross-sectional view of the excess flow valve of FIG. 1.

FIG. 8 is an expanded view of a portion of the excess flow valve of FIG. 1.

### DETAILED DESCRIPTION OF THE DRAWINGS

The description that follows describes, illustrates and exemplifies one or more embodiments of the present invention in accordance with its principles. This description is not provided to limit the invention to the embodiments described herein, but rather to explain and teach the principles of the invention in order to enable one of ordinary skill in the art to understand these principles and, with that understanding, be able to apply them to practice not only the embodiments described herein, but also other embodiments that may come to mind in accordance with these principles. The present specification is intended to be taken as a whole and interpreted in accordance with the principles of the present invention as taught herein and understood by one of ordinary skill in the art.

The scope of the present invention is intended to cover all such embodiments that may fall within the scope of the appended claims, either literally or under the doctrine of equivalents. The specification describes exemplary embodiments which are not intended to limit the claims or the claimed inventions. Features described in the specification, but not recited in the claims, are not intended to limit the claims.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose.

Some features may be described using relative terms such as top, bottom, vertical, rightward, leftward, etc. It should be appreciated that such relative terms are only for reference with respect to the appended drawings. These relative terms are not meant to limit the disclosed embodiments.

Excess flow valves disclosed herein are configured to prevent an excess amount of cryogenic fluid, such as liquid hydrogen, from flowing through an engine fuel supply line and/or a filling station at any given time. The excess flow valve is configured to be open when the flow rate of cryogenic fluid flowing through the excess flow valve is less than or equal to a predetermined threshold flow rate. The excess flow valve is configured to be closed when the flow rate of the cryogenic fluid exceeds the predetermined threshold flow rate (e.g., resulting from a line breakage) to prevent the cryogenic fluid from potentially spilling from the engine fuel supply line and/or the filling station due to the heightened flow rate. Once the flow rate of the cryogenic fluid returns to be less than or equal to the predetermined threshold, the excess flow rate is configured to return to the open position to again permit the cryogenic fluid to flow.

Example excess flow valves disclosed herein include a body, a piston plug, and a spring. The body includes an inner body surface that defines a chamber, an inlet, an outlet, and a valve seat. The piston plug is configured to slide axially within the chamber between an open position and a closed position. The piston plug includes a plug at a first end that is configured to engage the valve seat in the closed position and be disengaged from the valve seat in the open position. The piston plug also includes an inner piston surface that defines at least a portion of a fluid flow path for the cryogenic fluid through the excess flow valve. The spring is configured to bias the piston plug to be disengaged from the valve seat in the open position.

In one embodiment, the piston plug also includes an outer piston surface opposite the inner piston surface and an outer flange that extends radially outward from the outer piston surface at a second end opposite the first end. The outer flange of the piston plug, the outer piston surface of the piston plug, and the inner body surface of the body at least partially define a spring slot for the spring that is outside of the fluid flow path. That is, the fluid flow path extends through an interior of the piston plug and the spring slot extends circumferentially around an exterior of the piston plug such that the piston plug fluidly isolates and spaces apart the spring slot from the fluid flow path. Further, the outer flange defines a spring surface that engages an end of the spring. The spring presses against the flange surface to bias the piston plug in a direction toward the open position. By being positioned within the spring slot that is spaced apart and fluidly isolated from the fluid flow path, the spring is not directly exposed to excessive flow rates of the cryogenic fluid that may otherwise deform the spring over time. In turn, the configuration of the spring within the spring slot extends the life of the excess flow valve.

In another embodiment, the plug of the piston plug defines a bleed hole that keeps the inlet fluidly connected to the outlet when the piston plug is in the closed position. The bleed hole enables a relatively small amount of cryogenic fluid to flow through it when the piston plug is in the closed position. The bleed hole equalizes the pressure on the two opposing sides of the plug and, in turn, facilitates the plug in disengaging from the valve seat and returning to the open position once the flow rate decreases to be less than or equal to the predefined threshold. For example, if the excess flow rate is not the result of a line breakage and subsequently decreases over time, the bleed hole facilitates the plug in returning to the open position.

Other embodiments of the excess flow valve include a combination of the above-identified features. For example, an example excess flow valve disclosed herein includes a combination of the spring being housed outside of the fluid flow path and the bleed hole of the plug of the piston plug.

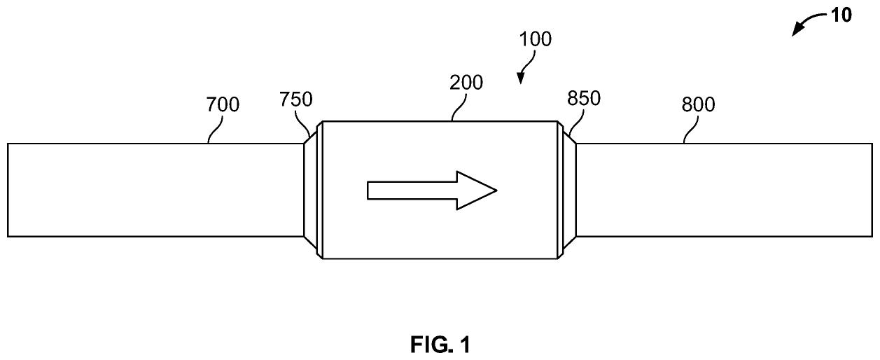

Turning to the figures, FIG. 1 illustrates an example excess flow assembly 10 in accordance with the teachings herein. The excess flow assembly 10 includes a excess flow valve 100, a pipe 700 (also referred to as a “first pipe”), and a pipe 800 (also referred to as a “second pipe”) that are fluidly connected together. The pipe 700 is coupled to a first end of the excess flow valve 100, and the pipe 800 is coupled to an opposing second end of the excess flow valve 100. In the illustrated example, the pipe 700 is coupled to the first end via a weld 750, and the pipe 800 is coupled to the second end via a weld 850. In other examples, the pipes 700, 800 are coupled to the excess flow valve 100 via any other means, such as threads, that securely and sealingly couple the pipes 700, 800 to the excess flow valve 100.

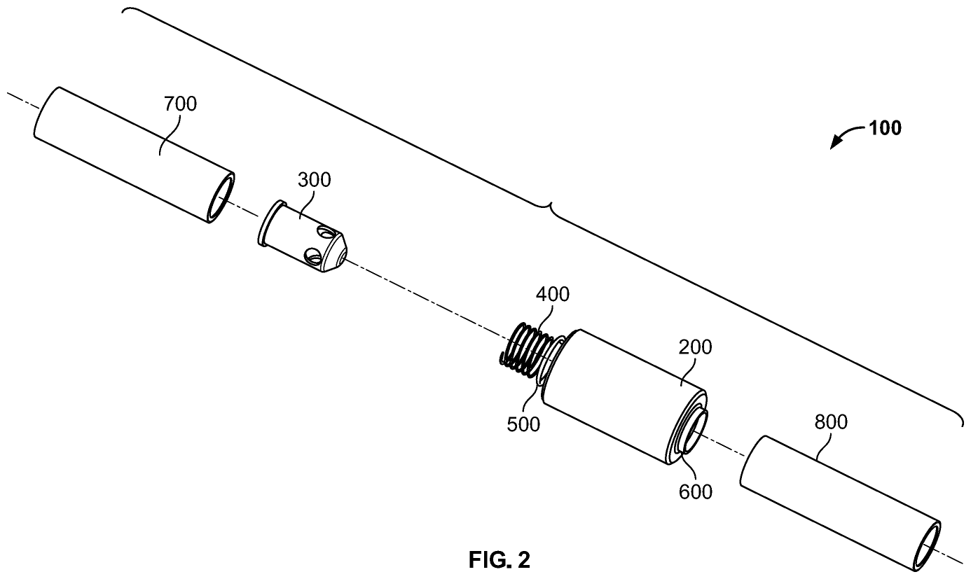

As shown in FIG. 2, the example excess flow valve 100 disclosed herein includes a valve body 200, a piston plug 300 (also referred to as a “piston,” “plug,” or “valve plug”), and a spring 400. In the illustrated example, the excess flow valve 100 also includes a retainer ring 500 and a guide 600. The components of the excess flow valve 100 are formed of material capable of withstanding and functioning in the extremely cold temperatures (e.g., around −253 degrees Celsius) associated with cryogenic fluids, such as liquid hydrogen. The valve body 200 is coupled to the pipe 700 and the pipe 800, for example, via the weld 750 and the weld 850, respectively.

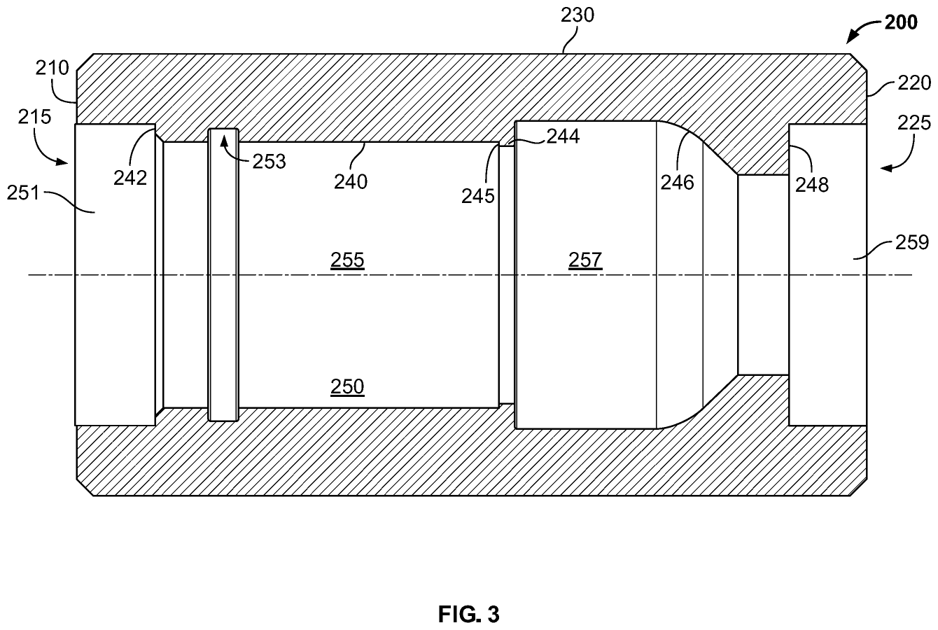

FIG. 3 is a cross-sectional side view of the valve body 200. The valve body 200 is a monolithically formed body. For example, the valve body 200 is a monolithic body composed of metallic material, such as austenitic stainless steel. The valve body 200 includes a first end 210 and a second end 220 that is opposite the first end 210. The valve body 200 also includes an inner body surface 240 and an outer body surface 230 that is opposite the inner body surface 240. The inner body surface 240 defines a chamber 250. The inner body surface 240 also defines an inlet 215 of the excess flow valve 100 at the first end 210 of the valve body 200 and an outlet 225 of the excess flow valve 100 at the second end 220 of the valve body 200. The chamber extends between the inlet 215 and the outlet 225. In the illustrated example, the chamber 250 extends axially along a longitudinal axis of the valve body 200.

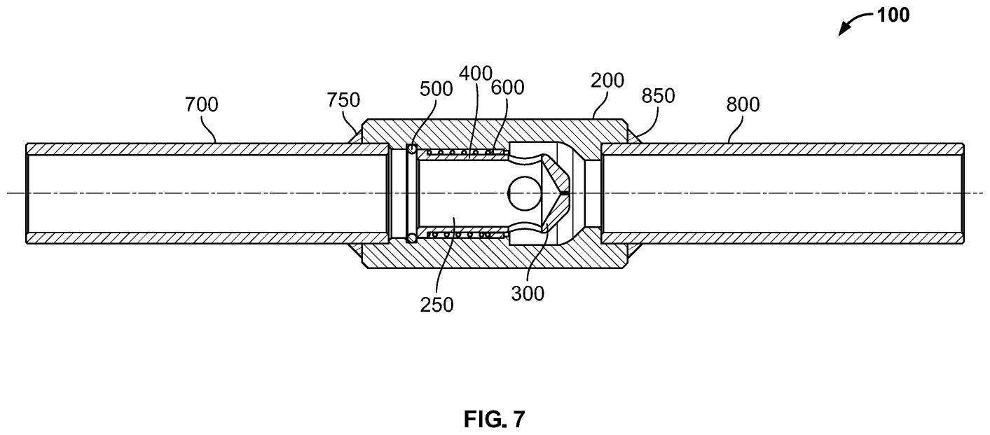

The valve body 200 includes a first lip 242 that extends radially adjacent the inlet 215 of the valve body 200. The first lip 242 defines a first pipe-receiving section 251 of the chamber 250 and a first pipe-receiving surface of the inner body surface 240 adjacent the inlet 215. As shown in FIG. 7, the inlet 215 and the first pipe-receiving section 251 are configured to receive the pipe 700. The first pipe-receiving surface defined by the first lip 242 is configured to engage an end of the pipe 700 to prevent the pipe 700 from extending farther into the chamber 250.

Returning to FIG. 3, the inner body surface 240 of the valve body 200 defines a groove 253 adjacent the first pipe-receiving section 251 and the inlet 215 such that the first pipe-receiving section 251 is located axially between the groove 253 and the inlet 215. In the illustrated example, the groove 253 is a circumferential groove. As shown in FIG. 7, the groove 253 is configured to securely receive and position the retainer ring 500 within the chamber 250.

Returning to FIG. 3, the valve body 200 also includes a second lip 248 that extends radially adjacent the outlet 225 of the valve body 200. The second lip 248 defines a second pipe-receiving section 259 of the chamber 250 and a second pipe-receiving surface of the inner body surface 240 adjacent the outlet 225. As shown in FIG. 7, the outlet 225 and the second pipe-receiving section 259 are configured to receive the pipe 800. The second pipe-receiving surface defined by the second lip 248 is configured to engage an end of the pipe 800 to prevent the pipe 800 from extending farther into the chamber 250.

Returning to FIG. 3, the valve body 200 includes a valve seat 246 that defines a valve seat surface of the inner body surface 240. The valve seat 246 is adjacent the second pipe-receiving section 259 and the outlet 225 such that the second pipe-receiving section 259 is located axially between the valve seat 246 and the outlet 225. In the illustrated example, the valve seat 246 defines the valve seat surface to be angled in a direction toward the longitudinal axis of the valve body 200 and the outlet 225. In other examples, the valve seat surface defined by the valve seat 246 is curved. The valve seat 246 is configured to sealingly engage the piston plug 300 in a closed position to prevent cryogenic fluid from flowing to and through the outlet 225 of the excess flow valve 100. The valve seat 246 also is configured to be disengaged from the piston plug 300 in an open position to permit cryogenic fluid to flow to and through the outlet 225 of the excess flow valve 100.

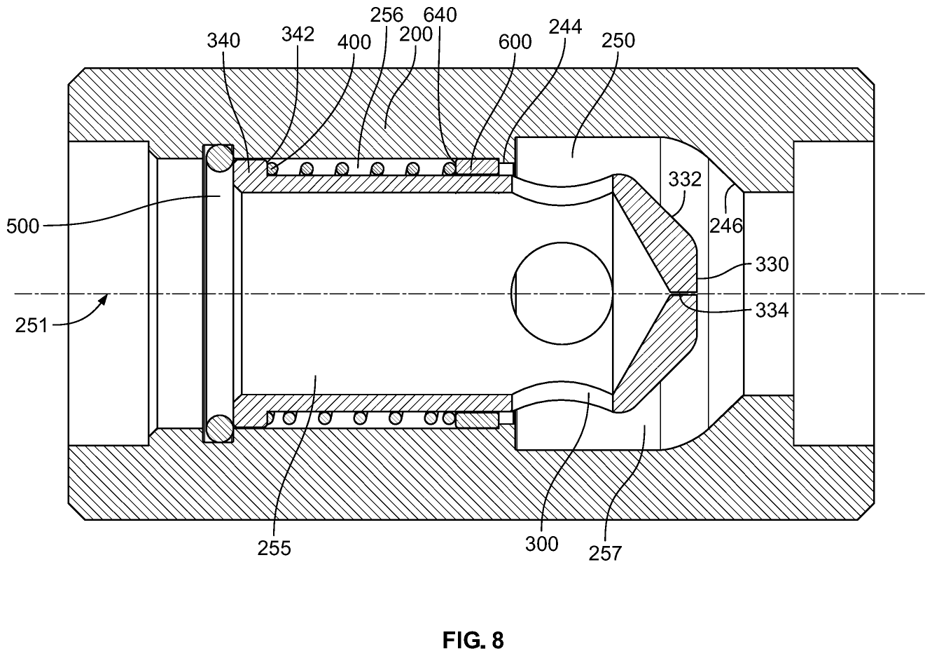

The valve body 200 of the illustrated example also includes an inner ledge 244 that defines a side surface 245. The inner ledge 244 extends into the chamber 250 inwardly toward the longitudinal axis of the valve body 200. The inner ledge 244 is located axially between the groove 253 and the valve seat 246. A first inner section 255 of the chamber 250 extends between the circumferential groove and the inner ledge 244. A second inner section 257 adjacent the first inner section 255 extends between the inner ledge 244 and the valve seat 246. As disclosed below in greater detail with respect to FIGS. 7 and 8, the first inner section 255 is configured to house the spring 400 and a portion of the piston plug 300, and the second inner section 257 is configured to house another portion of the piston plug 300. The inner ledge 244 forms an opening with a diameter greater than that of the body of the piston plug 300 to enable the piston plug 300 to slide axially between the first inner section 255 and the second inner section 257 of the chamber 250 and, in turn, enable the piston plug 300 to transition between the closed and open positions.

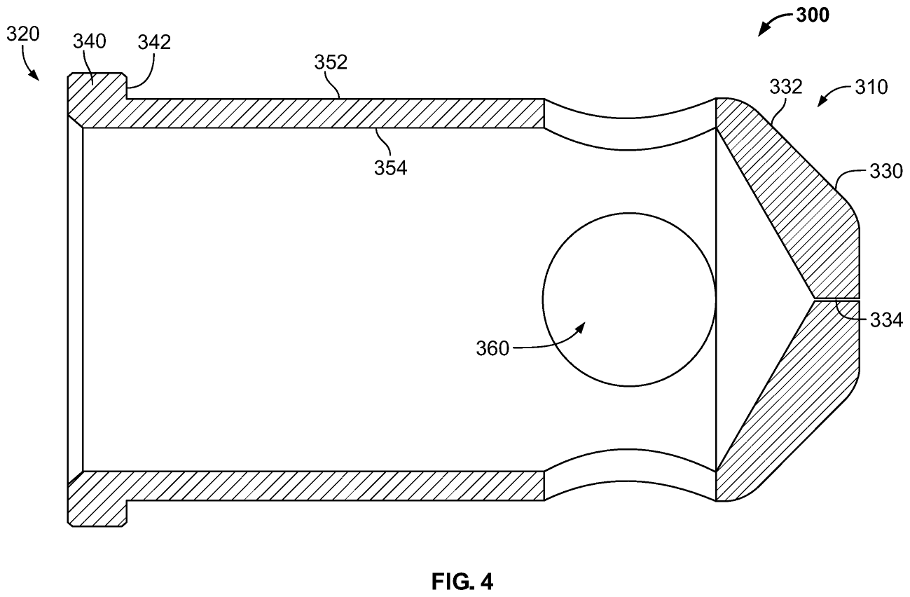

FIG. 4 is a cross-sectional side view of the piston plug 300. In the illustrated example, the piston plug 300 includes a first end 310 (also referred to as an “outlet end”) and a second end 320 (also referred to as an “inlet end”) opposite the first end 310. As illustrated in FIG. 7, the piston plug 300 is configured to be disposed within the chamber 250 of the valve body 200 with the first end 310 of the piston plug 300 being positioned toward the outlet 225 of the valve body 200 and the second end 320 of the piston plug 300 being positioned toward the inlet 215 of the valve body 200.

Returning to FIG. 4, the piston plug 300 includes a plug 330 located at the first end 310. The plug 330 defines a sealing surface 332 that is configured to sealingly engage the valve seat 246 when the piston plug 300 is in the closed position.

In the illustrated example, the piston plug 300 also defines a bleed hole 334. The bleed hole 334 extends between opposing sides of the plug 330 to keep the outlet 225 fluidly connected to the inlet 215 when the piston plug 300 is in the closed position. The bleed hole 334 has a relatively small diameter (e.g., about 0.5 millimeters) that enables the pressure on the two opposing sides of the plug 330 to equalize when the plug 330 is sealingly engaged to the valve seat 246. In turn, the bleed hole 334 facilitates the piston plug 300 in disengaging from the valve seat 246 and returning to the open position, for example, once a flow rate of the cryogenic fluid decreases to be less than or equal to a predefined threshold as disclosed below in greater detail. In the illustrated example, the bleed hole 334 is located at an apex of the plug 330. In other examples, the bleed hole 334 may be located at any other location on the plug 330 that fluidly connects the outlet 225 to the rest of the chamber 250 when the piston plug 300 is in the closed position. Further, in other examples, the plug 330 may define a plurality of bleed holes and/or one or more bleed slots to equalized the pressure within the chamber 250 when the piston plug 300 is in the closed position.

As shown in FIG. 4, the piston plug 300 includes an outer piston surface 352 and an inner piston surface 354 that is opposite the outer piston surface 352. Each of the outer piston surface 352 and the inner piston surface 354 extend between the plug 330 and the second end 320 of the piston plug 300 in a direction parallel to a longitudinal axis of the piston plug 300. The piston plug 300 also defines one or more holes 360 that are adjacent the plug 330. As disclosed below in greater detail with respect to FIGS. 7 and 8, the inner piston surface 354 and the holes 360 of the piston plug 300 define a portion of a fluid flow path along which the cryogenic fluid flows between the inlet 215 and the outlet 225 of the excess flow valve 100. Returning to FIG. 4, the piston plug 300 also includes an outer flange 340 that is located at and/or adjacent the second end 320. The outer flange 340 extends radially outward from and circumferentially about the outer piston surface 352. The outer flange 340 defines a flange surface 342 (also referred to as a “moving spring surface”). In the illustrated example, the flange surface 342 extends perpendicular to the longitudinal axis of the piston plug 300 and faces in a direction toward the first end 310.

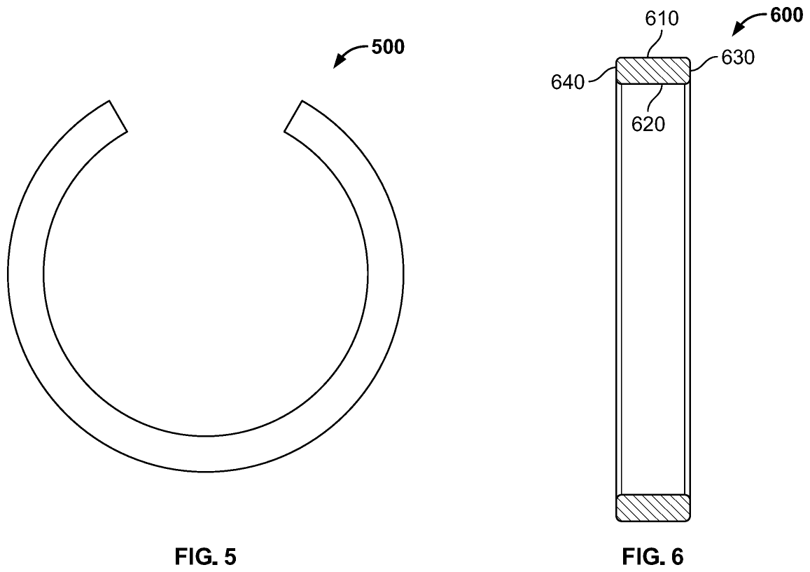

FIG. 5 is a front view of the retainer ring 500 that is configured to be securely housed in the groove 253 of the valve body 200. In the illustrated example, the retainer ring 500 is c- or u-shaped with two opposing ends. As disclosed below in greater detail, the retainer ring 500 is shaped to (i) flex inwardly to enable the retainer ring 500 to be inserted into the chamber 250 of the valve body 200 and (ii) snap outwardly back toward a rest state to secure the retainer ring 500 within the groove 253 of the valve body 200.

FIG. 6 is a cross-sectional side view of the guide 600. In the illustrated example, the guide 600 is a tube-shaped hollow cylinder. The guide 600 includes an outer surface 610 (also referred to as an “outer guide surface”), an inner surface 620 (also referred to as an “inner guide surface”), a side surface 630 (also referred to as a “first side surface”), and a side surface 640 (also referred to as a “second side surface,” a “fixed surface,” or a “fixed spring surface”) opposite the side surface 630. As disclosed below in greater detail, the outer surface 610 is configured to engage the inner body surface 240 of the valve body 200, the inner surface 620 is configured to slidably engage the outer piston surface 352 of the piston plug 300, and the side surface 630 is configured to engage the side surface 245 of the inner ledge 244 of the valve body 200. Additionally, the side surface 640 is configured to engage an end of the spring 400 that securely presses the guide 600 in place against the inner ledge 244.

FIG. 7 is a side cross-sectional side view of the excess flow assembly 10 when the excess flow valve 100 is assembled and resting in an open position, and FIG. 8 is an expanded cross-sectional side view of the excess flow valve 100 in the open position.

As illustrated in FIGS. 7 and 8, the retainer ring 500 is securely positioned within the groove 253 of the chamber 250 of the valve body 200. The piston plug 300 is housed within the chamber 250 of the valve body 200. A first portion of the piston plug 300 proximate the second end 320 is positioned within the first inner section 255 of the chamber 250, and a second portion of the piston plug 300 proximate the first end 310 is positioned within the second inner section 257 of the chamber 250. The guide 600 is also positioned within the first inner section 255 of the chamber 250. When the guide 600 is in place, the outer surface 610 engages the inner body surface 240 of the valve body 200, the inner surface 620 slidably engages the outer piston surface 352 of the piston plug 300, and the side surface 630 engages the inner ledge 244 of the valve body 200.

A spring slot 256 that houses the spring 400 is formed within the chamber 250. The spring slot 256 is a circumferential slot that extends circumferentially around a portion of the outer piston surface 352 of the piston plug such that the spring slot 256 is located along an outer radial portion of the first inner section 255 of the chamber 250. The spring slot 256 is at least partially defined by the flange surface 342 of the outer flange 340 of the piston plug 300, the outer piston surface 352 of the piston plug 300, and the inner body surface 240 of the valve body 200.

In the illustrated example, the spring slot 256 is defined by the flange surface 342, the outer piston surface 352, the inner body surface 240, and the side surface 640 of the guide 600. A first end of the spring 400 engages the flange surface 342 of the piston plug 300, and a second end of the spring 400 engages the side surface 640 of the guide 600. That is, the side surface 640 of the guide 600 partially defines the spring slot 256. The spring 400 presses against the side surface 640 to secure the guide 600 in place against the inner ledge 244 of the valve body 200 such that the second end of the spring 400 and the guide 600 are stationary during operation of the excess flow valve 100. The spring 400 presses against the outer flange 340 to bias the piston plug 300 in an open position. As disclosed below in greater detail, the piston plug 300 and, in turn, the outer flange 340 of the piston plug 300 is configured to slide axially along the longitudinal axis of the valve body 200 between the closed and open positions in a manner that compresses and expands the spring 400, respectively.

In another example, the excess flow valve 100 does not include the guide 600 with the spring slot 256 being defined by the flange surface 342, the outer piston surface 352, the inner body surface 240, and the side surface 245 of the valve body 200. That is, the inner ledge 244 partially defines the spring slot 256. The first end of the spring 400 engages the flange surface 342 of the piston plug 300, and the second end of the spring 400 engages the side surface 245 (also referred to as a “fixed surface” or a “fixed spring surface”) of the inner ledge 244. The spring 400 presses against the side surface 245 of the inner ledge 244 and is configured to remain stationary during operation of the excess flow valve 100. The spring 400 presses against the outer flange 340 to bias the piston plug 300 in the open position.

In FIGS. 7 and 8, the excess flow valve 100 is in the open position that enables cryogenic fluid to flow along a fluid flow path that extends from the inlet 215 and to the outlet 225. The fluid flow path extends through (i) the inlet 215, (ii) an interior of the piston plug 300 defined by the inner piston surface 354, (iii) the holes 360 of the piston plug 300, (iv) the second inner section 257 of the chamber 250, and (v) the outlet 225. As shown in FIG. 8, the holes 360 are located adjacent the plug such that the holes 360 remain axially positioned, in both the open position and the closed position, between the spring slot 256 and the valve seat 246 within the second inner section 257 of the chamber 250. In turn, the fluid flow path that extends through the holes 360 is diverted around the spring slot 256 that houses the spring 400 for all positions of the piston plug 300. Because the fluid flow path is diverted around the spring 400, the spring 400 is less likely to be deformed over time, thereby extending the life of the excess flow valve 100.

In operation, the spring 400 biases the piston plug 300 in the open position. The spring applies a biasing force to the outer flange 340 of the piston plug 300 in a direction toward the inlet 215. The biasing force of the spring 400 corresponds with a threshold flow rate of cryogenic fluid for the excess flow valve 100. Cryogenic fluid flowing along the fluid flow path applies an opposing force to the piston plug 300 in a direction toward the outlet 225. The force applies by the cryogenic fluid corresponds with the flow rate of the cryogenic fluid. A greater flow rate corresponds with a greater force applied by the cryogenic fluid onto the piston plug 300, and a lesser flow rate corresponds with a lesser force applied by the cryogenic fluid onto the piston plug 300.

When a flow rate of the cryogenic fluid is less than or equal to the threshold flow rate, the spring 400 pushes the piston plug 300 to the open position. That is, the spring 400 is in an extended state and pushes the outer flange 340 of the piston plug 300 to rest against the retainer ring 500 securely positioned within the groove 253 of the valve body 200. In turn, the plug 330 on the opposing side of the piston plug 300 is disengaged from the valve seat 246 to enable fluid to flow to and through the outlet 225 of the excess flow valve 100.

When the flow rate of the cryogenic fluid becomes greater than the threshold flow rate, the flow of the cryogenic fluid overcomes the biasing force of spring 400 and pushes the piston plug 300 to slide axially in a direction toward the valve seat 246 and the outlet 225. The outer flange 340 of the piston plug 300 is configured to compress the spring 400 into a compressed state as the piston plug 300 slides toward the valve seat 246. The plug 330 is configured to engage the valve seat 246 in the closed position when the spring is in the compressed state. The plug 330 engages the valve seat 246 in the closed position to prevent the cryogenic fluid from flowing through the excess flow valve 100 at elevated flow rates.

The excess flow valve 100 returns to the open position to again permit the cryogenic fluid to flow only after the flow rate of the cryogenic fluid returns to be less than or equal to the threshold flow rate. Once the flow rate becomes less than the threshold flow rate, the spring 400 pushes the piston plug back to the open position. In turn, the plug 330 disengages from the valve seat 246 to again permit cryogenic fluid to flow through the excess flow valve 100.

To assembly the excess flow assembly 10, the excess flow valve 100 is first assembled. The excess flow valve 100 is assembled by inserting the guide 600 and then the spring 400 through the inlet 215 and into the first inner section 255 of the chamber 250 of the valve body 200. The piston plug 300 is then inserted through the inlet 215 and into the first inner section 255 and the second inner section 257 of the chamber 250. The piston plug 300 is inserted into the chamber 250 such that the piston plug 300 extends through the spring 400 and the guide 600. Each of the inlet 215, the first pipe-receiving section 251, the groove 253, and the first inner section 255 has a respective diameter greater than those of the piston plug 300, the spring 400, and the guide 600 to enable the piston plug 300, the spring 400, and the guide 600 to be inserted into the first inner section 255 of the chamber 250 via the inlet 215. Additionally the valve seat 246 has a diameter less than those of the piston plug 300, the spring 400, and the guide 600 to prevent the piston plug 300, the spring 400, and the guide 600 from being remove from the chamber 250 via the outlet 225. Subsequently, the retainer ring 500 is inserted through the inlet 215 and securely positioned within the groove 253 of the chamber 250. The retainer ring 500 is flexible to enable the retainer ring 500 to flex inwardly as the retainer ring 500 is inserted into the chamber 250 and to snap back to a rest state once the retainer ring 500 is positioned within the groove 253. The retainer ring 500 is positioned within the groove 253 adjacent the inlet 215 to securely the piston plug 300, the spring 400, and the guide 600 in place within the chamber 250 of the valve body 200. Once the excess flow valve 100 is assembled, the pipe 700 is secured to the inlet 215 via the weld 750 and the pipe 800 is secured to the outlet 225 via the weld 850 to complete the assembly of the excess flow assembly 10.

1. An excess flow valve for cryogenic fluid, comprising:
a valve body including:
an inner body surface that defines an inlet, an outlet, a chamber extending between the inlet and the outlet; and
a valve seat adjacent the outlet;
a piston plug disposed within the chamber and configured to slide axially between an open position and a closed position, wherein the piston plug includes:
an inlet end positioned toward the inlet of the valve body;
an outlet end positioned toward the outlet of the valve body;
a plug at the outlet end configured to engage the valve seat in the closed position and be disengaged from the valve seat in the open position;
an inner piston surface at least partially defining a fluid flow path for the cryogenic fluid between the inlet and the outlet;
an outer piston surface; and
an outer flange extending radially outward from the outer piston surface at the inlet end, wherein the outer flange defines a flange surface;
wherein the outer flange, the outer piston surface, and the inner body surface at least partially define a spring slot that is outside of the fluid flow path; and
a spring disposed in the spring slot and including a first end that engages the flange surface to bias the piston plug toward the open position.

2. The excess flow valve of claim 1, wherein the valve body includes an inner ledge extending into the chamber between the inlet and the outlet.

3. The excess flow valve of claim 2, wherein the inner ledge partially defines the spring slot and defines a fixed surface that engages a second end of the spring.

4. The excess flow valve of claim 2, further comprising a guide adjacent the inner ledge, wherein the guide includes a side surface that engages the inner ledge and a fixed surface that partially defines the spring slot and engages a second end of the spring.

5. The excess flow valve of claim 1, further comprising a guide positioned to partially define the spring slot and engage a second end of the spring, wherein the guide includes an outer guide surface that engages the inner body surface of the valve body and an inner guide surface that engages the outer piston surface of the piston plug.

6. (canceled)

7. (canceled)

8. The excess flow valve of claim 1, wherein the piston plug is configured to slide axially toward the valve seat when a flow rate of the cryogenic fluid exceeds a predefined threshold flow rate that corresponds with a biasing force of the spring.

9. The excess flow valve of claim 8, wherein the outer flange is configured to compress the spring as the piston plug slides axially toward the valve seat.

10. The excess flow valve of claim 1, wherein the outlet end of the plug defines a bleed hole that fluidly connects the inlet to the outlet when the piston plug is in the closed position to equalize pressure between the chamber and the outlet to subsequently facilitate the piston plug in returning to the open position.

11. The excess flow valve of claim 1, wherein the inlet is configured to receive and fluidly connect to a first pipe, and wherein the outlet is configured to receive and fluidly connect to a second pipe.

12. The excess flow valve of claim 1, wherein the inlet has a first diameter greater than that of the piston plug and the spring to enable the piston plug and the spring to be inserted into the chamber through the inlet, wherein the valve seat has a second diameter less than that of the piston plug and the spring to prevent the piston plug and the spring from being removed from the chamber through the outlet.

13. The excess flow valve of claim 1, further comprising a retainer ring securely positioned within the chamber adjacent the inlet to retain the piston plug and the spring in place within the chamber.

14. The excess flow valve of claim 13, wherein the inner body surface of the valve body defines a circumferential groove configured to receive the retainer ring.

15. The excess flow valve of claim 13, wherein the outer flange of the piston plug is configured to rest against the retainer ring in the open position.

16. The excess flow valve of claim 1, wherein the spring is disposed in the spring slot to fluidly isolate the spring from the fluid flow path.

17. An excess flow valve for cryogenic fluid, comprising:
a valve body including:
an inner body surface that defines an inlet, an outlet, a chamber extending between the inlet and the outlet; and
a valve seat adjacent the outlet;
a piston plug disposed within the chamber and configured to slide axially between an open position and a closed position, wherein the piston plug includes:
a plug configured to engage the valve seat in the closed position and be disengaged from the valve seat in the open position;
an inner piston surface at least partially defining a fluid flow path for the cryogenic fluid between the inlet and the outlet; and
an outer piston surface,
wherein the piston plug defines one or more holes adjacent the plug, the one or more holes at least partially forming the fluid flow path between the inlet and the outlet;
wherein the outer piston surface and the inner body surface at least partially define
a spring slot that is outside of and fluidly isolated from the fluid flow path; and
a spring disposed in the spring slot and configured bias the piston plug toward the open position.

18. The excess flow valve of claim 17, wherein the one or more holes are located adjacent the plug such that the one or more holes are axially positioned between the spring slot and the valve seat in both the open position and the closed position to direct the cryogenic fluid around the spring in both the open position and the closed position.

19. The excess flow valve of claim 17, wherein the plug defines a bleed hole that fluidly connects the inlet to the outlet when the piston plug is in the closed position to equalize pressure between the chamber and the outlet to subsequently facilitate the piston plug in returning to the open position.

20. The excess flow valve of claim 17, wherein the inlet is configured to receive and fluidly connect to a first pipe, and wherein the outlet is configured to receive and fluidly connect to a second pipe.

21. An excess flow valve for cryogenic fluid, comprising:
a valve body including:
an inner body surface that defines an inlet, an outlet, a chamber extending between the inlet and the outlet; and
a valve seat adjacent the outlet;
a piston plug disposed within the chamber and configured to slide axially between an open position and a closed position, wherein the piston plug includes:
a plug configured to engage the valve seat in the closed position and be disengaged from the valve seat in the open position;
an inner piston surface defining at least a portion of a fluid flow path for the cryogenic fluid between the inlet and the outlet; and
an outer piston surface,
wherein the outer piston surface and the inner body surface at least partially define
a spring slot that is outside of and fluidly isolated from the fluid flow path; and
a spring disposed in the spring slot and configured bias the piston plug toward the open position,
wherein the plug is configured to be disengaged from the valve seat in the open position when the spring is in an extended state, and
wherein the plug is configured to engage the valve seat in the closed position when the spring is in a compressed state.

22. The excess flow valve of claim 21, wherein the piston plug is configured to slide axially toward the valve seat when a flow rate of the cryogenic fluid exceeds a predefined threshold flow rate that corresponds with a biasing force of the spring, and wherein the spring is configured to compress as the piston plug slides axially toward the valve seat.

23. The excess flow valve of claim 21, wherein the piston plug further includes an outer flange extending radially outward from the outer piston surface, and wherein the spring includes a first end that engages the outer flange to bias the piston plug toward the open position.

24. The excess flow valve of claim 21, wherein the valve body includes an inner ledge extending into the chamber between the inlet and the outlet, and wherein the spring includes a second end configured to press against the inner ledge.
